(19) United States
(12) Patent Application Publication
(10) Pub. No.: US 2020/0324696 A1
(43) Pub. Date: Oct. 15, 2020

(54) LIGHTING CONTROL SYSTEM AND LIGHTING CONTROL METHOD

(71) Applicant: Yazaki Corporation, Tokyo (JP)

(72) Inventor: Ryo HIRAMATSU, Makinohara-shi (JP)

(73) Assignee: Yazaki Corporation, Tokyo (JP)

(21) Appl. No.: 16/814,301

(22) Filed: Mar. 10, 2020

(30) Foreign Application Priority Data
Apr. 12, 2019 (JP) 2019-076262

(51) Int. Cl. B60Q 3/80; H05B 47/13; H05B 47/16; H05B 47/11; B60Q 3/233

(52) U.S. Cl. CPC B60Q 3/80; H05B 47/13; B60Q 3/233; H05B 47/11; H05B 47/16

(57) ABSTRACT

An objective of the present invention is to suppress judgment omissions, determine the presence or absence of a bending action of a passenger, and control a foot lighting. The objective is achieved by a lighting control system comprising a foot lighting for illuminating a lower area of a seat installed in a vehicle cabin of a vehicle, an information acquisition unit for acquiring distance measurement information of an interior of the vehicle cabin from a front side reference position in a vehicle cabin, a determination unit for determining based on the distance measurement information at least whether a passenger of the vehicle has performed a bending action for moving his head forward and downward or not, and a control unit for performing on/off-control of the foot lighting based on a determination result by at least the determination unit.

### BACKGROUND OF THE INVENTION

### Technical Field

The present invention relates to a lighting control system and a lighting control method for controlling foot lighting installed in a vehicle cabin in a vehicle.

### Background Art

When a passenger in a vehicle tries to find an object dropped at the foot, there are cases in which it is dark in a foot area which is a lower area of the seat wherein the position of the fallen object is difficult to recognize.

Therefore, a technique is proposed to install a foot lighting for illuminating the lower area of the seat in a vehicle cabin, acquire an image of an interior of the vehicle cabin, and determine based on the acquired image whether the passenger has performed a bending action which is registered in to turn on the foot lighting based on the determination result (e.g., see Patent Document 1.). When the passenger performs a bending action in order to search for the fallen object, this technology enables the foot lighting to be turned on automatically in response to this bending action.

### CITATION LIST

### Patent Literature

Patent Document 1: JP 2016-107864 A

### SUMMARY OF THE INVENTION

According to the above technology, it is necessary to register in advance a bending action which is a trigger for turning on the foot lighting, but it depends on actual cases with what attitude the passenger performs the bending action. In order to be able to determine the presence or absence of the bending action with as few omissions as possible, it is necessary to register bending actions with various expected cases, such a registration operation is not only complicated, it is not clear after all how effectively it can suppress the judgment omissions.

Accordingly, the present invention is directed to the above-described problems, and an objective thereof is to provide an lighting control system and an lighting control method capable of determining the presence or absence of a bending action of a passenger with suppressed judgment omissions to control foot lighting.

In order to solve the above problems, a lighting control system according to the present invention includes a foot lighting for illuminating a lower area of a seat installed in a vehicle cabin of a vehicle, an information acquisition unit for acquiring distance measurement information of an interior of the vehicle cabin from a front side reference position in the vehicle cabin, a determination unit for determining based on the distance measurement information at least whether a passenger of the vehicle performed a bending action in which his head is moved forward and downward, and a control unit for performing on/off-control of the foot lighting based on at least a determination result of the determination unit.

Further, in order to solve the above problems, the lighting control method of the present invention includes an information acquisition step of obtaining distance measurement information of an interior of a vehicle cabin of a vehicle from the front side reference position in the vehicle cabin, a determination step of determining based on the distance measurement information at least whether a passenger of the vehicle performed a bending action in which his head is moved forward and downward, a control step of performing based on a determination result in the determination step on/off-control of the foot lighting for illuminating a lower area of a seat installed in the vehicle cabin.

According to the lighting control system and the lighting control method of the present invention, since the distance measurement information inside the vehicle cabin, i.e., the three-dimensional information inside the vehicle cabin, is acquired, it is possible to determine not only movement of a passenger in a lateral direction and a vertical direction, but also movement in a longitudinal direction. In addition thereto, whether the bending action was performed is determined based on the comprehensive judgment criteria that the head of the passenger moved forward and downward. According to the lighting control system and the lighting control method of the present invention, since comprehensive judgment criteria which rely on such three-dimensional information acquisition is employed, it is possible to determine the presence or absence of the bending action of the passenger with suppressed judgment omissions to control the foot lighting.

### BRIEF DESCRIPTION OF THE DRAWINGS

FIG. 1 is a schematic diagram illustrating an embodiment of a lighting control system;

FIG. 2 is a schematic block diagram of the lighting control system shown in FIG. 1.

FIG. 3 is a flowchart illustrating a flow of processing in a lighting control method executed in the lighting control system illustrated in FIGS. 1 and 2;

FIG. 4 is a diagram schematically illustrating determination of a bending action performed in the processing of the stepped S106 illustrated in FIG. 3; and

FIG. 5 is a schematic view illustrating an example of how an interior of the cabin is when the lighting control method is executed in accordance with the flowchart shown in FIG. 3.

### DETAILED DESCRIPTION OF THE PREFERRED EMBODIMENTS

Hereinafter, an embodiment of a lighting control system will be described.

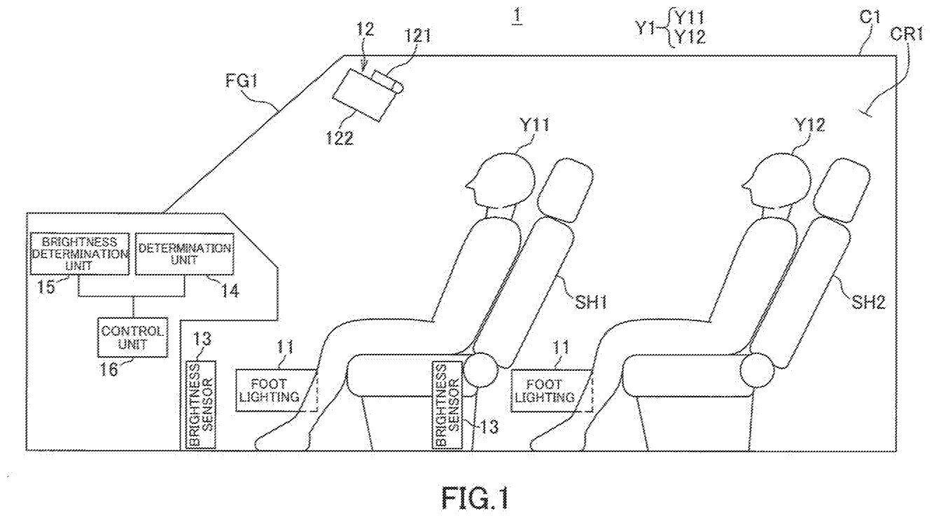

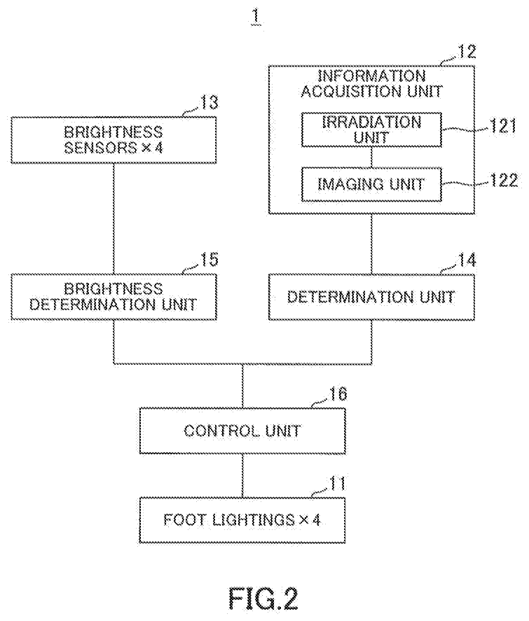

FIG. 1 is a schematic diagram illustrating an embodiment of a lighting control system. FIG. 2 is a schematic block diagram of the lighting control system shown in FIG. 1.

The lighting control system 1 according to the present embodiment is installed in a cabin CR1 in a vehicle C1 and controls lightings for illuminating a foot area of a passenger Y1. The lighting control system 1 includes foot lightings 11, an information acquisition unit 12, brightness sensors 13, a determination unit 14, a brightness determination unit 15, and a control unit 16.

The foot lightings 11 are installed in the cabin CR1 of the vehicle C1 and illuminate a lower area of each of a front seat SH1 and a rear seat SH2, wherein the foot lightings are installed at two locations on the front seat SH1 side and two locations on the rear seat SH2 side in the lower portion of the vehicle body, totally at four locations.

The information acquisition unit 12 acquires distance measurement information of an interior of the vehicle cabin CR1 from a front side reference position in the vehicle cabin CR1. Specifically, the information acquisition unit 12 is an imaging device which images the vehicle cabin CR1 and obtains a three-dimensional image that also represents a distance to an object within the imaging range of the vehicle cabin CR1. As such an imaging device, although not specified herein, a conventional known camera or the like having a distance measurement function such as a stereo camera or a TOF (Time-of-Flight) camera may be employed as examples.

Further, the imaging device as the information acquisition unit 12 includes an irradiation unit 121 for irradiation with infrared radiation, and an imaging unit 122 capable of acquiring an image in an infrared range in order to enable imaging even when it is dark in the vehicle cabin CR1. The imaging unit 122 is located near an upper edge of a windshield FG1 so that both the front seat passenger Y11 sitting on the front seat SH1 and the rear seat passenger Y12 sitting in the rear seat SH2 are included within the imaging range. This installation position corresponds to the front side reference position according to the present embodiment. Moreover, the irradiation unit 121 is attached to the imaging unit 122 so as to be able to sufficiently cover the imaging range of the imaging unit 122.

Brightness sensors 13 are sensors for measuring the brightness of the lower area of each seat, at two locations on the front seat SH1 side and two locations on the rear seat SH2 side, i.e. totally at four locations.

Based on the distance measurement information acquired by the information acquisition unit 12, the determination unit 14 determines whether any of the passengers Y1 of the vehicle C1, such as the front seat passenger Y11 and the rear seat passenger Y12 performed a bending action with movement of the head forward and downward. Further, the determination unit 14 also determines whether the passenger Y1 who performed the above-described bending action performed a return action of returning the head backward and upward.

The brightness determination unit 15 determines whether the measurement result by the brightness sensor 13 is less than a predetermined threshold value.

The control unit 16, based on the determination result in the determination unit 14 and the determination result in the brightness determination unit 15, performs on/off-control of the foot lighting 11. That is, the control unit 16 performs on/off-control based on whether the measurement result by the brightness sensor 13 is less than a predetermined threshold value or not, whether the bending action is performed by any of the passengers Y1 or not. Specifically, if it is determined by the determination unit 14 that the bending action is performed by any passenger Y1, where the measurement result by the brightness sensor is less than the threshold value, the control unit 16 turns on the foot lighting 11 for a seat on which the passenger Y1 who performed the bending action is sitting. Further, the control unit 16 turns off the foot lighting 11 once turned on, when it is determined by the determination unit 14 that the return operation is performed by the passenger Y1 who performed the bending action. The foot lighting 11 which has been once turned on is also turned off by the control unit 16, when the elapsed time from turning on the foot illumination 11 reaches a predetermined upper limit time. Further, the control unit 16 turns on the foot lighting 11 so as to gradually increase its brightness, and turns off the foot lighting 11 which has been once turned on so as to gradually decrease its brightness.

Of the components of the lighting control system 1 described above, the determination unit 14, the brightness determination unit 15, and the control unit 16 are functional blocks configured in an ECU (Electronic Control Unit) mounted on the vehicle C1.

Next, a lighting control method executed in the lighting control system 1 will be described.

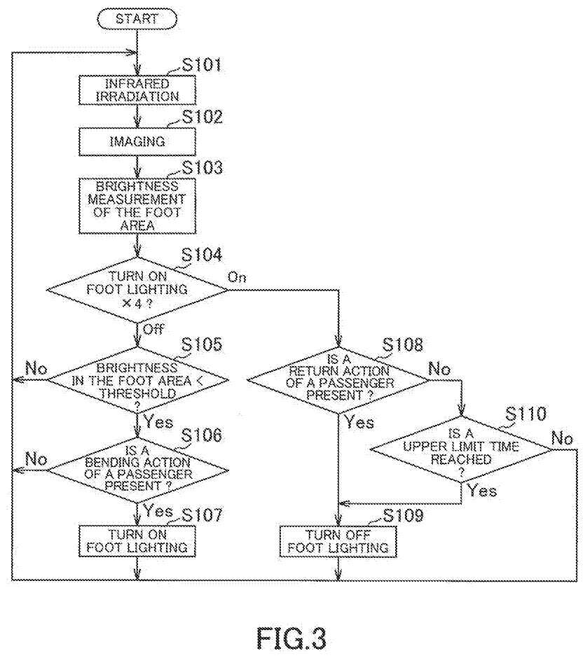

FIG. 3 is a flowchart illustrating a flow of processing in a lighting control method executed in the lighting control system illustrated in FIGS. 1 and 2.

The lighting control method shown in FIG. 3 starts when power is supplied to the ECU of the vehicle C1. When the process starts, irradiation with infrared radiation by the irradiation unit 121 of the information acquisition unit 12 (step S101), the imaging by the imaging unit 122 under the irradiation (step S102), the brightness measurement by the brightness sensors 13 (step S103), are executed. The processing of the step S101, S102 corresponds to an example of the information acquisition step of acquiring the distance measurement information from the front side reference position in the cabin CR1. Further, the processing of the step S103 corresponds to an example of a brightness measurement step of measuring the brightness of the lower area of each seat of the vehicle cabin CR1.

Next, it is determined by the determination unit 14 for each of the four foot lightings 11, whether they have been turned on or not (step S104). Regarding the foot lighting 11 (off-determination in the step S104) which has been determined as not being on, it is determined by the brightness determination unit 15 whether the brightness of the object to be irradiated is less than the threshold value or not (step S105). The processing of the step S105 corresponds to an example of a brightness determination step of determining whether the measurement result of the brightness is less than a predetermined threshold value.

When it is determined that the brightness is less than the threshold value (Yes—determination in the step S105), it is determined by the determination unit 14 whether the passenger Y1 at the position corresponding to the foot lighting 11 performed the bending action or not (step S106). This determination is performed on the basis of the three-dimensional image as the distance measurement information obtained by the imaging unit 122.

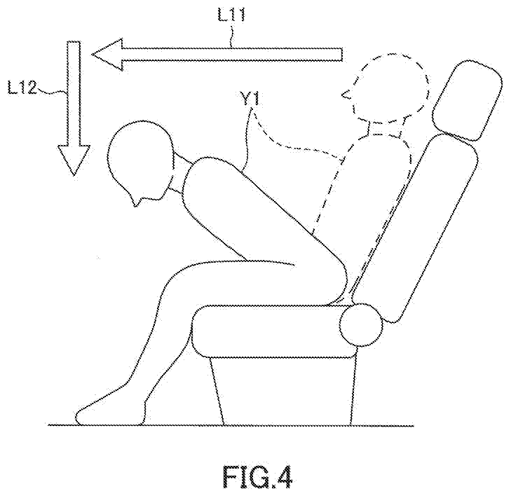

FIG. 4 is a diagram schematically illustrating a determination of a bending action performed in the process of the stepped S106 illustrated in FIG. 3.

According to the present embodiment, since the imaging device as the information acquisition unit 12 acquires a three-dimensional image also representing the distance to the object within the imaging range as the distance measurement information, it is possible to determine the movement of the passenger Y1 not only in the lateral direction and the vertical direction but also in the longitudinal direction. Based on such a three-dimensional image, the following determination is made in the process of the step S106 of FIG. 3. That is, in the processing herein, when the head of the passenger Y1 is moved so that the forward movement amount L11 and the downward movement amount L12 exceed the respective predetermined thresholds, it is determined that the bending action is performed by the passenger Y1.

In the process of the step S106 of FIG. 3, when it is determined that the bending action has been performed (Yes—determination in the step S106), the foot lighting 11 illuminating the foot area of the passenger Y1 is turned on by the control unit 16 (step S107). This foot lighting 11 is turned on so as to increase the brightness gradually. Thereafter, the process returns to the step S101 and the subsequent processes are repeated. The processing of the step S106 corresponds to an example of a determination step of determining on the basis of the distance measurement information acquired in the above-described information acquisition step whether the passenger Y1 performed a bending action or not (step S101, S102).

When it is determined that the brightness is not less than the threshold value (No—determination in the step S105), when it is determined that the bending action has not been performed (No—determination in the step S106), the foot lighting 11 is not turned on and the process returns to the step S101 and subsequent processes are repeated.

On the other hand, for the foot lighting 11 (on-determination in the step S104) which is determined as being turned on in the step S104, it is determined by the determination unit 14 whether the passenger Y1 performed the return action or not (step S108).

For this return action, although not shown, determination of movement in an opposite direction to that of the bending action described with reference to FIG. 4 is performed. That is, if the head of the passenger Y1 is moved so that the amount of the backward movement and the amount of the upward movement exceed respective predetermined thresholds, it is determined that the return action was performed by the passenger Y1.

Then, if it is determined that the return action was performed (Yes—determination of the step S108), the foot lighting 11 is turned off by the control unit 16 (step S109). This turning off is performed so as to gradually decrease the brightness. Thereafter, the process returns to the step S101 and the subsequent process is repeated. On the other hand, if it is determined that the return action has not been performed (No—determination of the step S108), it is determined by the control unit 16 whether the elapsed time since the corresponding foot lighting 11 was turned on reaches the predetermined upper limit time or not (step S110). When it is determined that the upper limit time has been reached (Yes determination of the step S110), the process proceeds to the step S109 in which the foot lighting 11 is turned off. When it is determined that the upper limit time has not yet been reached (No—determination of the step S110), the foot lighting 11 is not turned off, but the process returns to the step S101 and subsequent processes are repeated. The processing of the step S108 corresponds to an example of a determination step of whether the passenger Y1 has performed the return action or not, and the processing of the step S107, S109 corresponds to an example of a control step of performing the on/off-control of the foot lighting 11. The process of the step S110 corresponds to an example of a step in which the control unit 16 determines for turning off the foot lighting 11 whether the elapsed time from the turning on has reached the upper limit time.

Processing of the flowchart shown in FIG. 3 is repeatedly executed until the power supply of the ECU of the vehicle C1 is cut off.

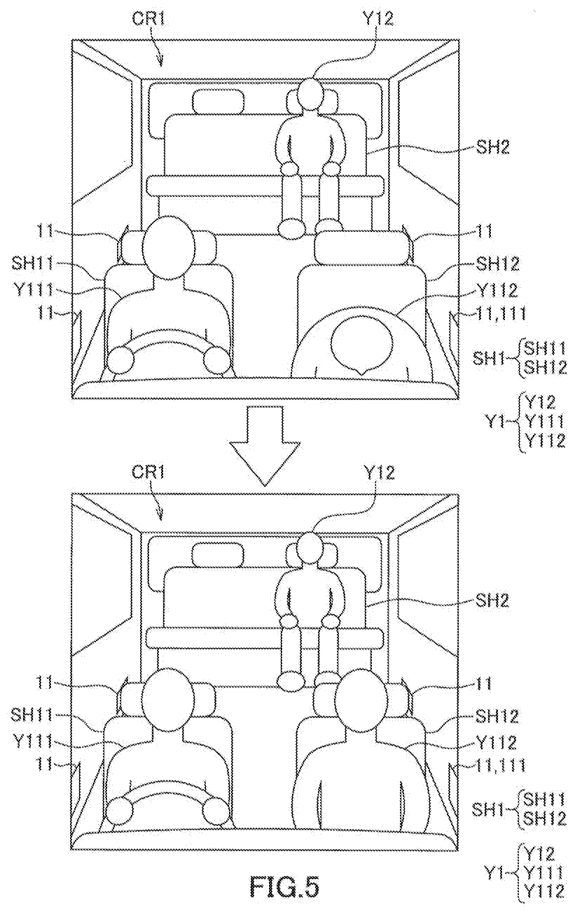

FIG. 5 is a schematic view illustrating an example of how the interior of the cabin is when the lighting control method is executed in accordance with the flowchart shown in FIG. 3.

In the example of FIG. 5, a driver Y111 of the passengers Y1 is seated in a driver's seat SH11, a front passenger Y112 is sitting on a front passenger seat SH12 of the front seats SH1, and a rear seat passenger Y12 are sitting on the rear seat SH2. In this instance, if the front passenger Y112 of the front passenger seat SH12 performs a bending action, the foot lighting 111 illuminating the lower area of the front passenger seat SH12 will be turned on out of the four foot lighting 11 when the brightness of the lower area of the front passenger seat SH12 is less than a threshold.

Then, when the front passenger Y112 performs the return action after the foot lighting 111 is turned on, the foot lighting 111 is turned off.

According to the lighting control system 1 and the lighting control method of the embodiment described above, it is possible to determine the three-dimensional movements of the passengers Y1 as described above. In addition thereto, whether the bending action was performed is determined based on the comprehensive judgment criteria that the head of the passenger moved forward and downward. According to the present embodiment, since comprehensive judgment criteria which rely on such three-dimensional information acquisition is employed, it is possible to determine the presence or absence of the bending action of the passengers Y1 with suppressed judgment omissions to control the foot lightings 11.

Here, it is preferable in the present embodiment, since, for the seat on which the passenger Y1 is sitting who was determined to have performed the bending action, the foot area of the passenger Y1 who has performed the bending action is illuminated in a pinpoint manner.

Further, according to the present embodiment, it is preferable since the turning off the foot lighting 11 is also performed automatically in accordance with the return action of the passenger Y1.

Further, the present embodiment is preferable since, even if the bending action of the passenger Y1 is caused unintentionally e.g. by falling asleep and natural movement of the head, the foot lighting 11 is turned off regardless of movement of the passenger Y1 automatically if the elapsed time reaches the upper limit time.

Also, in the present embodiment, the foot lighting is turned on so that its brightness increases gradually and is turned off so that its brightness decreases gradually. It can be expected that lighting that turns on with gradually increasing brightness or turns off with gradually decreasing brightness alleviates discomfort to those who see it. According to the present embodiment, it is preferable because the on/off-control of the foot lighting 11 is performed in this manner.

Further, according to the present embodiment, since the on/off-control of the foot lighting 11 is performed on the basis of the brightness of the lower area of the seat in the cabin CR1, it is possible to reduce turning on of unnecessary foot lightings 11 in case that it is bright.

Further, according to the present embodiment, since the distance measurement information is considered as an image together with the movement of the passenger or the like, the presence or absence of the bending action can be more accurately determined.

Further, according to the present embodiment, the imaging device as the information acquisition unit 12 includes an irradiation unit 121 for irradiation with infrared radiation, an imaging unit 122 capable of acquiring an image in the infrared range. According to such an imaging device, even when it is dark in the vehicle cabin, it is possible to further accurately determine the presence or absence of the bending action since the image in the infrared range is acquired.

It is to be noted that the embodiments described above merely show exemplary embodiments representative for the lighting control system and the lighting control method, the lighting control system and the lighting control method can be implemented in various variations rather than limited thereto.

For example, the above-described embodiment shows a lighting control system 1 as an example in which foot lightings 11 are installed at two locations on the front seat SH1 side, two locations on the rear seat SH2 side, i.e. on four locations in total in the lower portion of the vehicle body. Also, for the information acquisition unit, the information acquisition unit 12 is illustrated as an example which has the imaging unit 122 installed with a vicinity area of the upper edge of the windshield FG1 as the front side reference position as well as the irradiation unit 121 attached to this imaging unit 122. However, the installation position of each of these components is not limited to those according to the above embodiment, but may be located at any position which fulfills a performance required by each of the components.

Further, according to the above-described embodiment, the determination unit 14, the brightness determination unit 15, and the control unit 16 configured in the ECU mounted on the vehicle C1 are exemplified. However, the configuration site of these components is not limited to the ECU, but may be a computer device or the like mounted on the vehicle C1 separately from the ECU.

Further, according to the above-described embodiment, as an example of a brightness sensor, four brightness sensors 13 for measuring the brightness of the lower areas of the seats are exemplified. However, the brightness sensor is not limited thereto and may be, for example, one or more sensors for measuring the brightness of the interior of the vehicle cabin CR1 or one or more sensors for measuring the brightness of an exterior of the vehicle cabin CR1.

Further, in the above-described embodiment, a lighting control system 1 and a lighting control method are exemplified in which the foot lighting 11 is turned on for a seat on which the passenger Y1 is sitting who has performed the bending action. However, the lighting control system and the lighting control method are not limited thereto and may, for example, turn on the foot lighting 11 so as to illuminate the lower areas of all seats at once when any passenger Y1 performs a bending action. However, as described above, by turning on the foot lighting 11 for the seat where the passenger Y1 is sitting who performed the bending action, it is preferable that the foot area of the passenger is illuminated in a pinpoint manner.

Further, according to the above-described embodiment, a lighting control system 1 and a lighting control method are exemplified in which the presence or absence of a return action of the passenger Y1 is also determined, and the foot lighting 11 which was once turned on is turned off if the return action is performed. Further, according to the present embodiment, the foot lighting 11 which was once turned on is also to be turned off when the elapsed time from turning on the foot lighting 11 reaches a predetermined upper limit time. However, the lighting control system and the lighting control method are not limited thereto, and turning off the foot lighting 11 which was once turned on may be performed by manual operation by a passenger. However, as described above as well, turning off the foot lighting 11 is automatically performed in accordance with the return action and the elapsed time as described above, thereby eliminating efforts of the passenger which is preferable.

Further, according to the above-described embodiment, lighting control system 1 and lighting control method are exemplified in which the control unit 16 turns on the foot lighting 11 so as to gradually increase its brightness and turns it off so as to gradually decrease its brightness. However, the lighting control system is not limited thereto and may be such that turning on/off the foot lighting is performed in a stepped fashion. However, as described above, the effect of gradually increasing the brightness of the foot lighting when it is turned on and gradually decreasing it when it is turned off can be expected to alleviate the discomfort of people who see it.

Further, according to the above-described embodiment, a lighting control system and a lighting control method are exemplified in which on/off-control of the foot lighting 11 is performed on the basis of a determination result of whether the measurement result of the brightness of the lower area of the seat is less than a threshold value. However, the lighting control systems and the lighting control methods are not limited thereto, and the on/off control of the foot lighting 11 may be performed based on the presence or absence of the bending action of the passenger Y1 regardless of the brightness inside the cabin CR1. However, by performing the on/off-control of the foot lighting 11 on the basis of the brightness in the lower area of the seat or the like, it is also possible to suppress turning on unnecessary vehicle cabin lighting in case it is bright as described above.

Further, in the above-described embodiment, a lighting control system 1 and a lighting control method are exemplified in which, as the distance measurement information, a three-dimensional image is obtained that also represents the distance to the object within the imaging range. However, the lighting control system and the lighting control method are not limited thereto, but may acquire the distance measurement information from the front side reference position as a simple distance data. However, as described above as well, the presence or absence of the bending action can be more accurately determined by obtaining the image as the distance measurement information.

Further, according to the above-described embodiment, a lighting control system 1 and a lighting control method are exemplified in which irradiation with infrared radiation is performed to capture an image in the infrared range to obtain the above-described image. However, the lighting control system and the lighting control method are not limited thereto, but may capture only an image in the visible light range. However, by enabling the image in the infrared range to be imaged, it is also possible to more accurately determine the presence or absence of the bending action even when it is dark in the cabin, as described above as well.

### REFERENCE SIGNS LIST

1 Lighting control system
11 Foot lighting
12 Information acquisition unit
13 Brightness sensor
14 determination unit
15 Brightness determination unit
16 Control unit
121 Irradiation unit
122 Imaging unit
C1 vehicle
CR1 vehicle cabin
SH1 front seat
SH2 rear seat
Y1 passenger
Y11 front seat passenger
Y111 driver
Y112 front passenger
Y12 rear seat passenger

What is claimed is:

1. A lighting control system comprising:
a foot lighting that illuminates a lower area of a seat installed in a vehicle cabin of a vehicle;
an information acquisition unit for acquiring distance measurement information of an interior of the vehicle cabin from a front side reference position in the vehicle cabin;
a determination unit for determining based on the distance measurement information at least whether a passenger of the vehicle performed a bending action in which his head is moved forward and downward; and
a control unit for performing on/off-control of the foot lighting based on at least a determination result of the determination unit.

2. The lighting control system according to claim 1, wherein the control unit turns on the foot lighting for a seat on which the passenger is sitting who performed the bending action when it is determined in the determination unit that the bending action has been performed.

3. The lighting control system according to claim 1,
wherein the determination unit also determines whether the passenger who has performed the bending action has performed a return action of returning the head backward and upward or not,
wherein the control unit turns off the foot lighting which was once turned on, when it is determined in the determination unit that the return action was performed.

4. The lighting control system according to claim 2,
wherein the determination unit also determines whether the passenger who has performed the bending action has performed a return action of returning the head backward and upward or not,
wherein the control unit turns off the foot lighting which was once turned on, when it is determined in the determination unit that the return action was performed.

5. The lighting control system according to claim 1,
wherein the control unit turns off the foot lighting which was once turned on when an elapsed time since the foot lighting was turned on reaches a predetermined upper limit time.

6. The lighting control system according to claim 2,
wherein the control unit turns off the foot lighting which was once turned on when an elapsed time since the foot lighting was turned on reaches a predetermined upper limit time.

7. The lighting control system according to claim 3,
wherein the control unit turns off the foot lighting which was once turned on when an elapsed time since the foot lighting was turned on reaches a predetermined upper limit time.

8. The lighting control system according to claim 4,
wherein the control unit turns off the foot lighting which was once turned on when an elapsed time since the foot lighting was turned on reaches a predetermined upper limit time.

9. The lighting control system according to claim 1,
wherein the control unit turns on the foot lighting so as to gradually increase its brightness.

10. The lighting control system according to claim 2,
wherein the control unit turns on the foot lighting so as to gradually increase its brightness.

11. The lighting control system according to claim 3,
wherein the control unit turns on the foot lighting so as to gradually increase its brightness.

12. The lighting control system according to claim 4,
wherein the control unit turns on the foot lighting so as to gradually increase its brightness.

13. The lighting control system according to claim 5,
wherein the control unit turns on the foot lighting so as to gradually increase its brightness.

14. The lighting control system according to claim 6,
wherein the control unit turns on the foot lighting so as to gradually increase its brightness.

15. The lighting control system according to claim 7,
wherein the control unit turns on the foot lighting so as to gradually increase its brightness.

16. The lighting control system according to claim 1,
wherein the control unit turns off the foot lighting which was once turned on so as to gradually reduce its brightness.

17. The lighting control system according to claim 1, comprising:
a brightness sensor for measuring brightness of at least any location of the interior and an exterior of the vehicle cabin and the lower area of the seat; and
a brightness determination unit for determining whether a measurement result of the brightness sensor is less than a predetermined threshold value or not;
wherein the control unit, in addition to the determination result in the determination unit, performs the on/off-control based on a determination result in the brightness determination unit.

18. The lighting control system according to claim 1,
wherein the information acquisition unit is an imaging device for imaging the vehicle cabin and obtaining an image additionally representing a distance to an object within an imaging range of the vehicle cabin.

19. The lighting control system according to claim 18,
wherein the imaging device comprises:
an irradiation unit for irradiation with infrared radiation; and
an imaging unit capable of acquiring an image in an infrared range.

20. Lighting control method comprising:
an information acquisition step of obtaining distance measurement information of an interior of a vehicle cabin of a vehicle from a front side reference position in the vehicle cabin;
a determination step of determining based on the distance measurement information at least whether a passenger of the vehicle performed a bending action in which his head is moved forward and downward; and
a control step of performing based on a determination result in the determination step on/off-control of a foot lighting for illuminating a lower area of a seat installed in the vehicle cabin.
